(19) United States
(12) Patent Application Publication
(10) Pub. No.: US 2005/0117088 A1
(43) Pub. Date: Jun. 2, 2005

(54) Display device

(75) Inventor: Pieter Joseph Clara Van Der Wel, Heerlen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/502,406

(22) PCT Filed: Dec. 20, 2002
(86) PCT No.: PCT/IB02/05670

(30) Foreign Application Priority Data
Jan. 25, 2002 (EP) 02075313.3

(51) Int. Cl. G02F 1/1335

(52) U.S. Cl. 349/63; 349/113

(57) ABSTRACT

A light guide has a material (liquid) with a refractive index higher than glass or plastic between glass or plastic surfaces (substrates). One of the substrates is structured (microprism like structures) at the side of the liquid and does not belong to the actual light guide anymore, so it can be flat at an outer side of the light guide.

The invention relates to a display device comprising an image display panel having a first substrate which is provided with electrodes at the area of pixels, and an illumination system comprising an optical waveguide having an exit face facing the image display panel and a plurality of end faces, at least one of which is an entrance face for light, while light can be coupled into said end face of the optical waveguide.

The image display panel may comprise an electro-optical medium (between two substrates) such as a liquid crystal material or an electrochromic material. It may also be based on electrostatic forces (deformable mirrors).

Such reflective display devices are used in, for example, portable apparatus such as laptop computers, mobile telephones, personal organizers, etc. With a view to saving energy, it is desirable that the light source can be switched off in the case of sufficient ambient light.

The invention also relates to an illumination system for use in such a display device.

A display device of the type mentioned above is described in “Compact Front Lighting for Reflective Displays”, SID 96 Applications Digest, pp. 43-46. This document shows an optical waveguide having a groove structure at the area of a first main face remote from the image display panel. The groove structure is necessary to deflect light rays into the direction of the image display panel. A problem in this case is that the groove structure makes it difficult to apply further layers, such as for instance an anti-reflection layer or other functional layers on the said first main face.

It is an object of the present invention to provide a solution to this problem. To this end in a display device according to the invention an optical waveguide comprises an optically transparent material between two optically transparent layers the optically transparent material having a higher refractive index than the material of the optically transparent layers, the interface between the optically transparent material and a first of said optically transparent layers at the side away from the image display panel being structured.

Preferably the interface has a sawtooth structure or a prism structure.

To prevent polarization effects both the optically transparent material and the material of the optically transparent layers preferably are substantially optically anisotropic.

These and other aspects of the invention will now be elucidated with reference to the drawings. In these drawings,

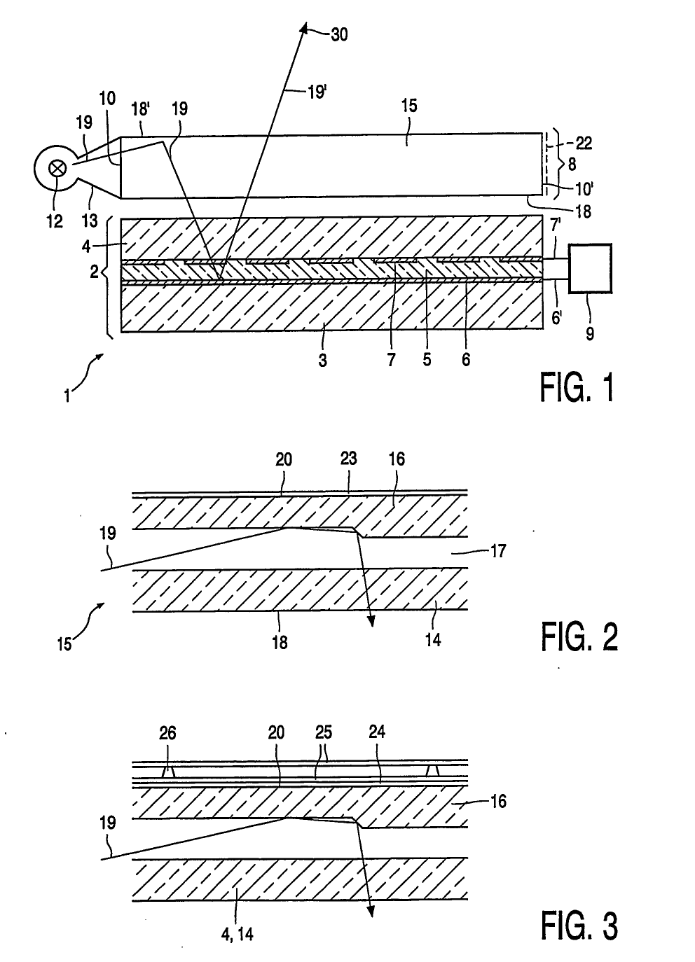

FIG. 1 is a cross-section of an embodiment of a reflective display device according to the invention while

FIG. 2 is a diagrammatic cross section of a part of the illumination system used in the device shown in FIG. 1 and

FIG. 3 shows a further embodiment of a part of another embodiment of the illumination system.

The Figures are diagrammatic and not to scale. Corresponding components generally have the same reference numerals.

The display device 1 shown diagrammatically in FIG. 1 comprises an image display panel 2 and an illumination system 8.

The image display panel 2 comprises a liquid crystalline material 5 between two substrates 3, 4, based on the twisted nematic (TN), the supertwisted nematic (STN) or the ferroelectric effect. The image display panel comprises, for example, a matrix of pixels for which light-reflecting picture electrodes 6 are provided on the substrate 3. The substrate 4 is light transmissive and has one or more light-transmissive electrodes 7 of, for example, ITO (indium tin oxide). The picture electrodes are provided with electric voltages via connection wires 6′, 7′, which are provided with, drive voltages by means of a drive unit 9.

The illumination system 8 comprises an optical waveguide 15 which is made of an optically transparent material and has four end faces 10, 10′. A light source 12 whose light is coupled into the optical waveguide 15 via one of the end faces, for example 10, is situated opposite this end face. The light source 12 may be, for example, a rod-shaped fluorescence lamp. The light source may alternatively be constituted by one or more light-emitting diodes (LED) notably in flat panel display devices having small image display panels such as, for example, portable telephones. Moreover, the light source 12 may be detachable.

The exit face 18 of the optical waveguide 15 faces the image display panel 2. Each end face 10′ of the transparent plate in which light is not coupled in may be provided, if necessary, with a reflector 22. In this way, light which is not coupled out on an exit face 18, 18′ and consequently propagates through the optical waveguide and arrives at an end face is thus prevented from leaving the optical waveguide 15 via this end face 10′.

To prevent light from leaving the optical waveguide 15 without contributing to the light output of the illumination system, light of the lamp 12 is preferably coupled into the optical waveguide 15 via coupling means 13, for example, by means of a wedge-shaped optical waveguide which limits the angle of the entering beam 19 with respect to the exit faces 18, 18′ to, for example, 15 degrees. Moreover, the contrast is enhanced because there is no stray light.

According to invention the optical waveguide 15, as shown in FIG. 2, has an optically transparent material 17 between two optically transparent layers (substrates) 14, 16. The optically transparent material 17 in this example is a liquid, such as a liquid suspension of TiO₂ particles, having a refractive index of about 2 which is higher than the refractive index of the optically transparent layers 14, 16 which in the case of glass transparent layers (substrates) 14, 16 is about 1.5. The interface between the optically transparent material 17 and the optically transparent layer is structured and comprises for instance a plurality of grooves in the transparent layer 16. The entering light beam 19 reflected by the surfaces of these grooves in the direction of the image display panel 2.

After reflection in the image display panel 2, the beam 19′ is propagated through the optical waveguide (refraction due to differences in refractive indices are considered to be negligible in this embodiment) and reaches the viewer 30 (FIG. 1).

Since the surface 20 is flat now, this may easily be covered with further layers such as an anti reflection coating 23.

In a further embodiment (not shown) the substrates 4,14 have been integrated into a single substrate (FIG. 3). In this case a polariser may be present between the transparent material 17 and said substrate.

The substrate 16 with the microstructure may be an ITO substrate—foil or a microreplicated foil.

Several variations are possible within the scope of the invention. For example, the grooves may have special patterns to enhance effectiveness or prevent Moire patterns.

The picture electrodes 6 do not need to be light reflecting. In another embodiment, they are used as light-transmissive ITO electrodes and a mirror is arranged behind these electrodes.

Especially in flexible displays when a polymerized material having electro-optical characteristics (like for instance PDLC) is used for the optically transparent material, the layer 17 may be patterned and inserted between plastic substrates.

The flat surface enables the integration of further functions. One example is shown in FIG. 3, in which a touch sensor (schematically drawn as layers 25, kept apart by spacers 26) is fixed to the surface 20 by means of glue 24.

The protective scope of the invention is not limited to the embodiments described. The invention resides in each and every novel characteristic feature and each and every combination of characteristic features. Reference numerals in the claims do not limit their protective scope. Use of the word “comprise” does not exclude the presence of elements other than those mentioned in the claims. Use of the word “a” or “an” preceding an element does not exclude the presence of a plurality of such elements.

1. A display device comprising an image display panel having a first substrate which is provided with electrodes at the area of pixels, and an illumination system comprising an optical waveguide having an exit face facing the image display panel and a plurality of end faces, at least one of which is an entrance face for light, while light can be coupled into said end face of the optical waveguide, said optical waveguide comprising an optically transparent material between two optically transparent layers the optically transparent material having a higher refractive index than the material of the optically transparent layers, the interface between the optically transparent material and a first of said optically transparent layers at the side away from the image display panel being structured.

2. A display device as claimed in claim 1 both the optically transparent material and the material of the optically transparent layers being substantially optically anisotropic.

3. A display device as claimed in claim 1 in which said first optically transparent layer is structured at the interface.

4. A display device as claimed in claim 1 in which the interface has a sawtooth structure or a prism structure.

5. A display device as claimed in claim 1 the optically transparent material being a liquid and the material of the optically transparent layers being glass, quartz or a synthetic material.

6. An illumination system comprising an optical waveguide of an optically transparent material, having an exit face and a plurality of end faces, at least one of said end faces being an entrance face for light situated opposite thereto, while light can be coupled into said end face of the optical waveguide, said optical waveguide comprising an optically transparent material between two optically transparent layers the optically transparent material having a higher refractive index than the material of the optically transparent layers the interface between the optically transparent material and the interface between the optically transparent material and a first of said optically transparent layer being structured.

7. An illumination system as claimed in claim 6 both the optically transparent material, the material of the optically transparent layers being substantially optically anisotropic

8. An illumination system as claimed in claim 6 in which one of the optically transparent layers is structured at the interface.

9. An illumination system as claimed in claim 6 in which the interface has a sawtooth structure or a prism structure.

10. An illumination system as claimed in claim 6 the optically transparent material being a liquid and the material of the optically transparent layers being glass, quartz or a synthetic material.
